(19) United States
(12) Patent Application Publication
(10) Pub. No.: US 2024/0098039 A1
(43) Pub. Date: Mar. 21, 2024

(54) SYSTEMS AND METHODS FOR PROVIDING RESILIENCE IN NETWORK COMMUNICATIONS

(71) Applicant: Mellanox Technologies, Ltd., Yokneam (IL)

(72) Inventors: Ioannis (Giannis) Patronas, Pireas (GR); Paraskevas Bakopoulos, Argiroupoli (GR); Dimitrios Syrivelis, Volos (GR); Nikolaos Argyris, Zografou (GR); Elad Mentovich, Tel Aviv (IL); Louis Bennie Capps, JR., Georgetown, TX (US); Prethvi Ramesh Kashinkunti, Chicago, IL (US); Julie Irene Marcelle Bernauer, Palo Alto, CA (US); Eitan Zahavi, Zichron Yaakov (IL)

(21) Appl. No.: 17/982,827

(22) Filed: Nov. 8, 2022

(30) Foreign Application Priority Data
Sep. 20, 2022 (GR) 20220100767

(51) Int. Cl. H04L 49/55

(52) U.S. Cl. CPC H04L 49/557

(57) ABSTRACT

Systems and methods for resilience in network communications are provided. An example system includes a first network port pair including a first input network port and a first output network port. The system further includes an intermediate switch configured to communicably connect the first input network port and the first output network port and a first redundant network port communicably connected with the intermediate switch. The intermediate switch establishes communication between the first input network port and the first redundant network port in an instance in which the intermediate switch receives an indication of a malfunction associated with the first output network port or establishes communication between the first output network port and the first redundant network port in an instance in which the intermediate switch receives an indication of a malfunction associated with the first input network port.

### CROSS-REFERENCE TO RELATED APPLICATIONS

This application claims priority to Greek Patent Application No. 20220100767, filed Sep. 20, 2022, the entire contents of which application are hereby incorporated herein by reference.

### TECHNOLOGICAL FIELD

Example embodiments of the present disclosure relate generally to network communications and, more particularly, to the providing resilience for communications between network ports.

### BACKGROUND

Datacenters and other networking environments (e.g., datacom, telecom, and/or other similar data/communication transmission networks) may include connections between switch systems, servers, racks, network ports, and other devices in order to provide for signal transmission between one or more of these elements. Network ports may include any device (e.g., switches, hosts, servers, and/or the like) by which data may be transferred, and these network ports strive to maintain consistent operability to avoid network outages. Applicant has identified a number of deficiencies and problems associated with network systems and associated communications. Through applied effort, ingenuity, and innovation, many of these identified problems have been solved by developing solutions that are included in embodiments of the present disclosure, many examples of which are described in detail herein.

### BRIEF SUMMARY

Systems, apparatuses, and methods for resilience in network communications are provided. An example system may include a first network port pair including a first input network port and a first output network port. The system may further include an intermediate switch configured to communicably connect the first input network port and the first output network port in an instance in which each of the first input network port and the first output network port are operable. The system may further include a first redundant network port communicably connected with the intermediate switch. The intermediate switch may be configured to establish communication between the first input network port and the first redundant network port in an instance in which the intermediate switch receives an indication of a malfunction associated with the first output network port. Alternatively, the intermediate switch may be configured to establish communication between the first output network port and the first redundant network port in an instance in which the intermediate switch receives an indication of a malfunction associated with the first input network port.

In some embodiments, the intermediate switch may be further configured to terminate communication between the first input network port and the first output network port in response to the indication of the malfunction associated with the first output network port or the first input network port.

In some further embodiments, the intermediate switch may be further configured to terminate communication between the first redundant network port and the first input network port and reestablish communication between the first input network port and the first output network port in response to an indication that the malfunction associated with the first output network port is resolved. In such an embodiment, the intermediate switch may further terminate communication between the first redundant network port and the first output network port and reestablish communication between the first input network port and the first output network port in response to an indication that the malfunction associated with the first input network port is resolved.

In some embodiments, the system may further include a second network port pair including a second input network port and a second output network port. In such an embodiment, the intermediate switch may communicably connect the second input network port and the second output network port in an instance in which the second input network port and the second output network port are operable. In such an embodiment, the intermediate switch further may be configured to establish communication between the second input network port and the first redundant network port in an instance in which the intermediate switch receives an indication of a malfunction associated with the second output network port or establish communication between the second output network port and the first redundant network port in an instance in which the intermediate switch receives an indication of a malfunction associated with the second input network port.

In some further embodiments, the system may include a second redundant network port communicably connected with the intermediate switch. In such an embodiment, the intermediate switch may be further configured to establish communication between the second redundant network port and the second output network port in an instance in which the intermediate switch receives an indication of a malfunction associated with the second input network port or establish communication between the second redundant network port and the second input network port in an instance in which the intermediate switch receives an indication of a malfunction associated with the second output network port.

In some embodiments, the intermediate switch may include a plurality of sub-switches.

In some embodiments, the first input network port, the first output network port, and the first redundant network port may be electrical switches, and the intermediate switch may be an optical switch.

In some embodiments, the system may further include an additional layer network port and an additional intermediate switch configured to communicably connect the additional layer network port and the first input network port in an instance in which the additional layer network port and the first input network port are operable. The system may further include a second redundant network port communicably connected with the additional intermediate switch, wherein the additional intermediate switch may be configured to establish communication between the additional layer network port and the second redundant network port in an instance in which the additional intermediate switch receives an indication of a malfunction associated with the first input network port or establish communication between the first input network port and the second redundant network port in an instance in which the additional intermediate switch receives an indication of a malfunction associated with the additional layer network port.

In some further embodiments, the additional intermediate switch may be further configured to terminate communication between the additional layer network port and the first input network port in response to the indication of the malfunction associated with the first input network port.

In any embodiment, the system may further include a controller operably coupled with the intermediate switch configured to direct communications between the first input network port, the first output network port, and the first redundant network port.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having described certain example embodiments of the present disclosure in general terms above, reference will now be made to the accompanying drawings. The components illustrated in the figures may or may not be present in certain embodiments described herein. Some embodiments may include fewer (or more) components than those shown in the figures.

FIG. 1 illustrates an example system for network resilience in accordance with various embodiments;

FIG. 2 illustrates another example system for network resilience with multiple network port pairs in accordance with various embodiments;

FIG. 3 is an exemplary block diagram of an intermediate switch for use with various embodiments of the present disclosure;

FIG. 4 is a flowchart illustrating an example method for providing network resilience in accordance with various embodiments of the present disclosure;

FIG. 5 is a flowchart illustrating an example method for providing network resilience in multiport implementations in accordance with various embodiments of the present disclosure;

FIG. 6 illustrates an example system for network resilience applied to a spine-leaf architecture in accordance with various embodiments of the present disclosure; and

FIG. 7 illustrates an example system for network resilience applied to a multilayer architecture in accordance with various embodiments of the present disclosure.

### DETAILED DESCRIPTION

### Overview

As described above, modern communication networks may include a large number of interconnected network devices referred to herein as network ports (e.g., switches, servers, hosts, etc.). These communication networks and systems often rely on network ports that are consistently operational to prevent, avoid, or substantially reduce the occurrences of network outages. Due to unintended malfunction, scheduled or unscheduled maintenance, varying environmental conditions, and/or the like, network ports may inevitably be inoperable. Conventional network resilience and failure recovery techniques leverage rigid algorithmic methods, such as modifying communication routing rules when a network port fails. These current resilience and failure recovery methods, however, are burdensome, inefficient, and reduce network performance. In other words, conventional systems and methods fail to provide network resilience solutions that dynamically address network port malfunctions without negatively impacting network performance.

In order to solve these issues and others, embodiments of the present disclosure provide for network resilience using an intermediate switch that is configured to reroute communication between operational ports and redundant network ports in an instance a network port is inoperable. For example, an input network port may be connected to a corresponding output network port to create a network port pair, and the network port pair may transmit data therebetween. The example intermediate switch (e.g., an optical switch or the like) may be communicably coupled to the input network port and the output network port and operate to direct and redirect network traffic. In an instance in which the intermediate switch receives an indication that one of the network ports is inoperable (e.g., malfunctioning, undergoing maintenance, or otherwise offline), the intermediate switch may establish communication between the operable network port of the network port pair and a redundant network port that is otherwise non-commissioned. In other words, the embodiments described herein may implement, leverage, or otherwise access network ports that intentionally remain offline or inoperable prior to required resilience operations (e.g., the purpose of the redundant network ports may be limited to providing resilience operations). In this way, the resilience embodiments of the present disclosure may eliminate or substantially reduce the impact of network port malfunction with minimal additional hardware.

As described herein, network ports forming a network port pair may be referred to with reference to “input” and “output” network ports such that each network port pair includes a respective input network port and output network port. As such, the terms “input” and “output” are used merely for illustrative purposes in that the data, signals, information, etc. that is transmitted by the network port pair may travel in either direction. In other words, an example input network port may operate as an output network port, and an example output network port may operate as an input network port. The present disclosure, therefore, contemplates that the network ports described herein may operate to transmit data, signals, and information to and receive data, signals, and information from any device communicably coupled thereto regardless of reference to input or output.

Furthermore, as would be evident to one of ordinary skill in the art in light of the present disclosure, the terms “substantially” and “approximately” indicate that the referenced element or associated description is accurate to within applicable engineering tolerances.

Embodiments of the present disclosure now will be described more fully hereinafter with reference to the accompanying drawings in which some but not all embodiments are shown. Indeed, the present disclosure may be embodied in many different forms and should not be construed as limited to the embodiments set forth herein; rather, these embodiments are provided so that this disclosure will satisfy applicable legal requirements. Like numbers refer to like elements throughout.

### Example Network Systems with Resilience

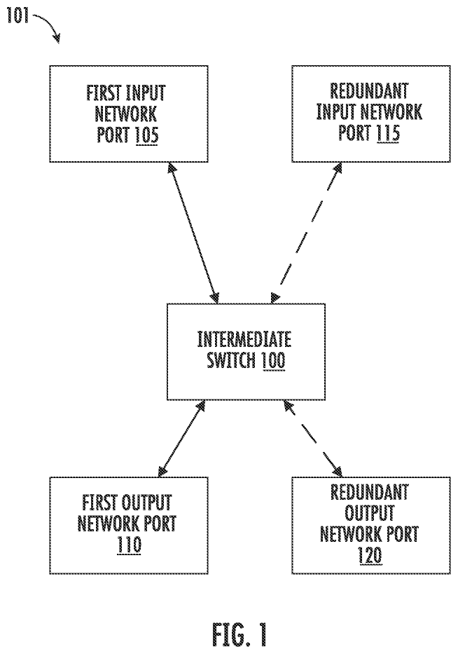

With reference to FIG. 1, an example system for resilience in network communications 101 is illustrated. As shown, the system 101 may include a first input network port 105 and a first output network port 110 that form a first network port pair. The first network port pair may be communicably coupled in the system 101 such that data, signal, information, and/or the like may be transmitted therebetween in an instance in which the first input network port 105 and the first output network port 110 are operable. To facilitate this communication, the system 101 may include an intermediate switch 100 that routes communication between the first input network port 105 and the first output network port as described hereafter. Each of the network ports that form the network port pairs (e.g., the first input network port 105 and the first output network port 110) of the system 101 may include any networking component or device, such as a switch, a server, a network interface controller (NIC), a networking card, a host, and/or the like. Said differently, the present disclosure contemplates that any network port described herein (e.g., input network port, output network port, additional layer network port, etc.) may refer to any networking device by, with, and/or through which data may be communicated.

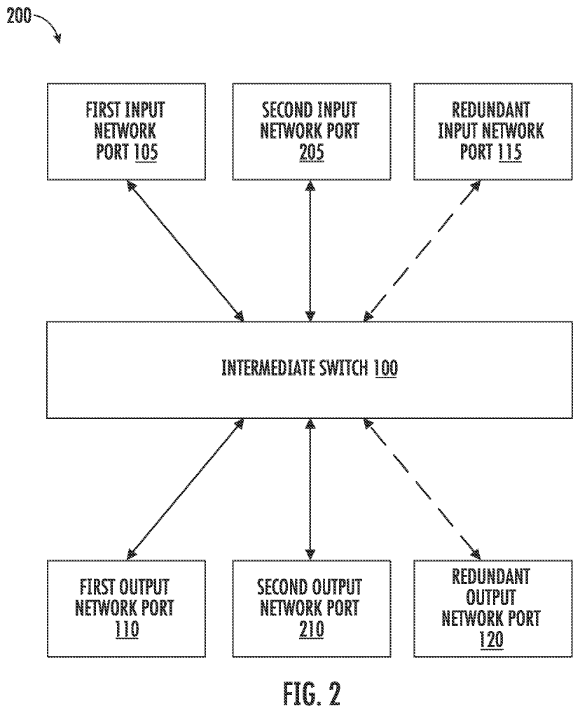

The first network port pair is illustrated in FIG. 1 as a simplified version of the system 101 in that only a first input network port 105 and a first output network port 110 are shown. As described herein, such as with reference to FIG. 2, the system 101 may include any number of input network ports and/or output network ports that may be formed as network port pairs due to their connectivity to one another. In the simplified illustration of FIG. 1, the first input network port 105 may be in communication with the first output network port 110 in an instance in which each of these ports 105, 110 are operable. As described above, instances may occur in which either of the network ports that form the first network port pair malfunction, are subjected to maintenance, or are otherwise offline or inoperable. Other than such an instance, the first input network port 105 and the first output network port 110 may be communicably coupled such that data may be transmitted therebetween. In some embodiments, the system 101 may include a plurality of input network ports that may be configured to be communicably coupled with a plurality of output network ports. Said differently, any of the plurality of input network ports may be communicably coupled to any of the output network ports based upon the intended application of the system 101. In various embodiments, the input network ports and the output network ports may be the same type of network port (e.g., all of the network ports are switches). Alternatively, the input network ports may be different in structure or operation than the output network ports (e.g., the input network ports may be electrical switches and the output network ports may be servers).

With continued reference to FIG. 1, the system 101 may further include the intermediate switch 100 that operates to route communication between the first input network port 105 and the first output network port 110. In some embodiments, the first input network port 105 may be communicably coupled with the first output network port 110 via the intermediate switch 100 such that, when operable, communications between the first input network port 105 and the first output network port 110 are directed via the intermediate switch 100. In other embodiments, the first input network port 105 and the first output network port 110 may be communicably coupled separate from the intermediate switch 100, and the intermediate switch 100 may operate only to redirect communications in the event of a malfunction as described hereinafter. In some embodiments, the intermediate switch 100 may be an optical switch configured to route communication between network ports. While the intermediate switch 100 is shown as a singular intermediate switch in FIG. 1, the present disclosure contemplates that various intermediate switches may be used to communicably couple the first input network port 105 (e.g., of a plurality of input network ports) and the first output network port 110 (e.g., of a plurality of output network ports).

In order to provide resilience to the system 101 in the event that either the first input network port 105 or the first output network port 110 malfunctions (e.g., device failure, maintenance, etc.), the system 101 may include one or more redundant network ports connected to the intermediate switch 100. In the simplified illustration of FIG. 1, a redundant input network port 115 (e.g., an example first redundant network port) and a redundant output network port 120 (e.g., another example first redundant network port) may be provided. The redundant input network port 115 may, for example, operate to provide resiliency for any of the input network ports (e.g., the first input network port 105), and the redundant output network port 120 may operate as a redundant switch for any of the output network ports (e.g., first output network port 110). Although illustrated as a distinct redundant input network port 115 and a redundant output network port 120, the present disclosure contemplates that a singular redundant network port (e.g., a first redundant network port) may operate to be selectively coupled with the first input network port 105 and the first output network port 110. In other words, in some embodiments, a redundant network port of the system 101 may be leveraged by input network ports and output network ports (e.g., a redundant network port that services multiple network layers).

The first redundant network port (e.g., the redundant input network port 115 and/or the redundant output network port 120) may be inoperable, inactive, dormant, or otherwise not communicably coupled with an active/operable network port. In this way, for example, the redundant input network port 115 may provide a backup or alternative network port for any input network port in communication with the intermediate switch 100. For example, if the first input network port 105 malfunctions, the redundant input network port 115 may replace the malfunctioning input network port. In some embodiments, the number of redundant network ports may indicate the number of network ports that could be offline at a given time without network interruption. Similarly, for example, the redundant output network port 120 may provide a backup or alternative network port for any output network port in communication with the intermediate switch 100. For example, if the first output network port 110 malfunctions, the redundant output network port 120 may replace the malfunctioning output network port. The redundant network ports described herein may, similar to the first input network port 105 and the first output network port 110, include any networking component or device, such as a switch, a server, a network interface controller (NIC), a networking card, a host, and/or the like.

With reference to FIG. 2, a system for network resilience 200 is illustrated that includes a plurality of input network ports and a plurality of output network ports. In addition to the components of system 101 in FIG. 1, the system 200 may include a second input network port 205 and a second output network port 210 that are also in communication with one another via the intermediate switch 100. Similar to the first network port pair described above, the second input network port 205 and the second output network port 210 may form a second network port pair. The second input network port 205 may be communicably connected with the second output network port 210 so that data may be transmitted therebetween. Although FIG. 2 only includes an additional network port pair, the system 200 may be configured to allow for any number of network port pairs, each of which may selectively access the redundant network ports discussed above. The present disclosure further contemplates that the system 200 may include any number of redundant network ports that are inactive, inoperable, dormant, and/or the like prior to malfunction of an operable input network port or an operable output network port.

### Example Intermediate Switch

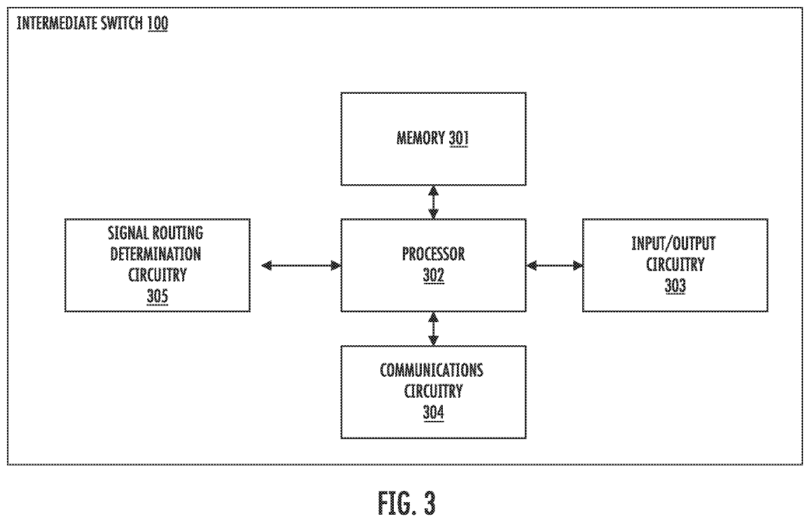

FIG. 3 illustrates a schematic block diagram of example circuitry, some or all of which may be included in an intermediate switch 100. The components discussed in FIG. 3 may be a part of the intermediate switch 100 or a controller, networking card, computing device, and/or the like that is associated with the intermediate switch 100. In accordance with some example embodiments, the intermediate switch 100 may include a memory 301, processor 302, input/output circuitry 303, and/or communications circuitry 304. Moreover, in some embodiments, signal routing determination circuitry 305 may also or instead be included in the intermediate switch 100. For example, where signal routing determination circuitry 305 is included in the intermediate switch 100, the signal routing determination circuitry 305 may be configured to facilitate the functionality discussed herein regarding establishing and/or terminating communication between various network ports and redundant network ports. An apparatus, such as the intermediate switch 100, may be configured, using one or more of circuitry 301-305, to execute the operations described herein.

Although the term “circuitry” as used herein with respect to components 301-305 is described in some cases using functional language, it should be understood that the particular implementations necessarily include the use of particular hardware configured to perform the functions associated with the respective circuitry as described herein. It should also be understood that certain of these components 301-305 may include similar or common hardware. For example, two sets of circuitries may both leverage use of the same processor, network interface, storage medium, or the like to perform their associated functions, such that duplicate hardware is not required for each set of circuitries. It will be understood in this regard that some of the components described in connection with the intermediate switch 100 may be housed within this device, while other components are housed within other devices (e.g., a controller in communication with the intermediate switch 100).

While the term “circuitry” should be understood broadly to include hardware, in some embodiments, the term “circuitry” also includes software for configuring the hardware. For example, in some embodiments, “circuitry” may include processing circuitry, storage media, network interfaces, input/output devices, and the like. In some embodiments, other elements of the intermediate switch 100 may provide or supplement the functionality of particular circuitry. For example, the processor 302 may provide processing functionality, the memory 301 may provide storage functionality, the communications circuitry 304 may provide network interface functionality, and the like.

In some embodiments, the processor 302 (and/or co-processor or any other processing circuitry assisting or otherwise associated with the processor) may be in communication with the memory 301 via a bus for passing information among components of, for example, intermediate switch 100. The memory 301 may be non-transitory and may include, for example, one or more volatile and/or non-volatile memories, or some combination thereof. In other words, for example, the memory 301 may be an electronic storage device (e.g., a non-transitory computer readable storage medium). The memory 301 may be configured to store information, data, content, applications, instructions, or the like, for enabling an apparatus, e.g., the intermediate switch 100, to carry out various functions in accordance with example embodiments of the present disclosure.

Although illustrated in FIG. 3 as a single memory, the memory 301 may comprise a plurality of memory components. The plurality of memory components may be embodied on a single computing device or distributed across a plurality of computing devices. In various embodiments, the memory 301 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. Memory 301 may be configured to store information, data, applications, instructions, or the like for enabling the intermediate switch 100 to carry out various functions in accordance with example embodiments discussed herein. For example, in at least some embodiments, the memory 301 is configured to buffer data for processing by the processor 302. Additionally or alternatively, in at least some embodiments, the memory 301 is configured to store program instructions for execution by the processor 302. The memory 301 may store information in the form of static and/or dynamic information. This stored information may be stored and/or used by the intermediate switch 100 during the course of performing its functionalities.

The processor 302 may be embodied in a number of different ways and may, for example, include one or more processing devices configured to perform independently. Additionally, or alternatively, the processor 302 may include one or more processors configured in tandem via a bus to enable independent execution of instructions, pipelining, and/or multithreading. The processor 302 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. The use of the term “processing circuitry” may be understood to include a single core processor, a multi-core processor, multiple processors internal to the apparatus, and/or remote or “cloud” processors. Accordingly, although illustrated in FIG. 3 as a single processor, in some embodiments, the processor 302 comprises a plurality of processors. The plurality of processors may be embodied on a single computing device or may be distributed across a plurality of such devices collectively configured to function as the intermediate switch 100. The plurality of processors may be in operative communication with each other and may be collectively configured to perform one or more functionalities of the intermediate switch 100 as described herein.

In an example embodiment, the processor 302 is configured to execute instructions stored in the memory 301 or otherwise accessible to the processor 302. Alternatively, or additionally, the processor 302 may be configured to execute hard-coded functionality. As such, whether configured by hardware or software methods, or by a combination thereof, the processor 302 may represent an entity (e.g., physically embodied in circuitry) capable of performing operations according to an embodiment of the present disclosure while configured accordingly. Alternatively, as another example, when the processor 302 is embodied as an executor of software instructions, the instructions may specifically configure processor 302 to perform one or more algorithms and/or operations described herein when the instructions are executed. For example, these instructions, when executed by processor 302, may cause the intermediate switch 100 to perform one or more of the functionalities of intermediate switch 100 as described herein.

In some embodiments, the intermediate switch 100 further includes input/output circuitry 303 that may, in turn, be in communication with the processor 302 to provide an audible, visual, mechanical, or other output and/or, in some embodiments, to receive an indication of an input from a user or another source. In that sense, the input/output circuitry 303 may include means for performing analog-to-digital and/or digital-to-analog data conversions. The input/output circuitry 303 may include support, for example, for a display, touchscreen, keyboard, mouse, image capturing device (e.g., a camera), microphone, and/or other input/output mechanisms. Input/output circuitry 303 may include a user interface and may include a web user interface, a mobile application, a kiosk, or the like. The input/output device may be used by a user to view and/or adjust malfunction indications (e.g., a user may indicate whether a malfunction has been resolved).

The processor 302 and/or user interface circuitry comprising the processor 302 may be configured to control one or more functions of a display or one or more user interface elements through computer-program instructions (e.g., software and/or firmware) stored on a memory accessible to the processor 302 (e.g., the memory 301, and/or the like). In some embodiments, aspects of input/output circuitry 303 may be reduced as compared to embodiments where the intermediate switch 100 may be implemented as an end-user machine or other type of device designed for complex user interactions. In some embodiments (like other components discussed herein), the input/output circuitry 303 may be eliminated from intermediate switch 100. The input/output circuitry 303 may be in communication with memory 301, communications circuitry 304, and/or any other component(s), such as via a bus. Although more than one input/output circuitry and/or other component can be included in the intermediate switch 100, only one is shown in FIG. 3 to avoid overcomplicating the disclosure (e.g., as with the other components discussed herein).

The communications circuitry 304, in some embodiments, includes any means, such as a device or circuitry embodied in either hardware, software, firmware or a combination of hardware, software, and/or firmware, that is configured to receive and/or transmit data from/to a network and/or any other device, circuitry, or module in communication with the intermediate switch. In this regard, the communications circuitry 304 may include, for example, a network interface for enabling communications with a wired or wireless communication network. For example, in some embodiments, communications circuitry 304 is configured to receive and/or transmit any data that may be stored by the memory 301 using any protocol that may be used for communications between computing devices. For example, the communications circuitry 304 may include one or more network interface cards, antennae, transmitters, receivers, buses, switches, routers, modems, and supporting hardware and/or software, and/or firmware/software, or any other device suitable for enabling communications via a network. Additionally or alternatively, in some embodiments, the communications circuitry 304 includes circuitry for interacting with the antenna(s) to cause transmission of signals via the antenna(e) or to handle receipt of signals received via the antenna(e). These signals may be transmitted by the intermediate switch 100 using any of a number of wireless personal area network (PAN) technologies, such as Bluetooth® v1.0 through v5.0, Bluetooth Low Energy (BLE), infrared wireless (e.g., IrDA), ultra-wideband (UWB), induction wireless transmission, or the like. In addition, it should be understood that these signals may be transmitted using Wi-Fi, Near Field Communications (NFC), Worldwide Interoperability for Microwave Access (WiMAX) or other proximity-based communications protocols. The communications circuitry 304 may additionally or alternatively be in communication with the memory 301, the input/output circuitry 303, and/or any other component of intermediate switch 100, such as via a bus. The communication circuitry 304 of the intermediate switch 100 may also be configured to receive and transmit information with the various network ports discussed herein.

In some embodiments, the intermediate switch 100 includes hardware, software, firmware, and/or a combination of such components, configured to support various aspects of signal routing in network ports as described herein. It should be appreciated that in some embodiments, the signal routing determination circuitry 305 performs one or more of such exemplary actions in combination with another set of circuitry of the intermediate switch 100, such as one or more of the memory 301, processor 302, input/output circuitry 303, and communications circuitry 304.

For example, in some embodiments, the signal routing determination circuitry 305 utilizes processing circuitry, such as the processor 302 and/or the like, to perform one or more of its corresponding operations. In a further example, and in some embodiments, some or all of the functionality of the signal routing determination circuitry 305 may be performed by processor 302. In this regard, some or all of the example processes and algorithms discussed herein can be performed by at least one processor 302 and/or signal routing determination circuitry 305. It should also be appreciated that, in some embodiments, signal routing determination circuitry 305 may include a separate processor, specially configured field programmable gate array (FPGA), or application specific interface circuit (ASIC) to perform its corresponding functions.

Additionally or alternatively, in some embodiments, the signal routing determination circuitry 305 uses the memory 301 to store collected information. For example, in some implementations, the signal routing determination circuitry 305 includes hardware, software, firmware, and/or a combination thereof, that interacts with the memory 301 to send, retrieve, update, and/or store data.

Accordingly, non-transitory computer readable storage media can be configured to store firmware, one or more application programs, and/or other software, which include instructions and/or other computer-readable program code portions that can be executed to direct operation of the intermediate switch 100 to implement various operations, including the examples shown herein. As such, a series of computer-readable program code portions may be embodied in one or more computer-program products and can be used, with a device, intermediate switch 100, database, and/or other programmable apparatus, to produce the machine-implemented processes discussed herein. It is also noted that all or some of the information discussed herein can be based on data that is received, generated and/or maintained by one or more components of the intermediate switch 100. In some embodiments, one or more external systems (such as a remote cloud computing and/or data storage system) may also be leveraged to provide at least some of the functionality discussed herein.

### Example Methods for Providing Resilience in Network Communications

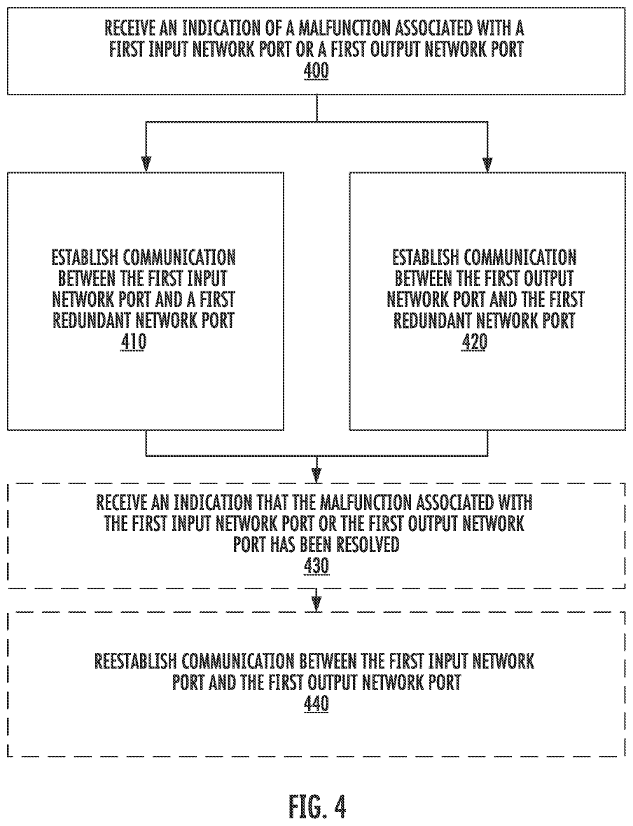

FIG. 4 illustrates an example method for providing resilience in network communications. The method may be carried out by embodiments of the system described herein (e.g., the intermediate switch 100 and/or related controllers). An example system may include at least one non-transitory storage device and at least one processing device coupled to the at least one non-transitory storage device, as described above. In such an embodiment, the at least one processing device may be configured to carry out the method discussed herein. While the operations of FIG. 4 are directed to a first network port pair (e.g., the first input network port 105 and the first output network port 110), various network port pairs may have communication redirected to a redundant network port as detailed herein.

Referring now to Block 400 of FIG. 4, the method may include receiving an indication of a malfunction associated with a first input network port or a first output network port. As discussed herein, the first input network port and the first output network port may be communicably connected in an instance in which each of the first input network port and the first output network port are operable. The indication of the malfunction associated with a first input network port or the first output network port may be, for example, provided via a transmission (e.g., a message) from the malfunctioning network port. Additionally or alternatively, the malfunction may be actively detected by the intermediate switch (e.g., the indication of a malfunction may be a change in the volume, speed, and/or any characteristic of the data received (or lack thereof) by the intermediate switch from the malfunctioning network port).

The indication of malfunction may be received in an instance in which the particular network port is currently offline or is required to be offline. For example, the indication of malfunction may indicate that the first input network port or the first output network port are malfunctioning, need maintenance, and/or any other reason(s) that the network port is going to (or currently is) offline, inoperable, inactive, etc. In some instances, the indication of malfunction may be received before the associated network port is offline to allow for the intermediate switch to use a redundant network port to prevent any outages in the network. For example, if a network port is in the process of failing or requires imminent maintenance, the intermediate switch may receive the indication of malfunction while the network port is online to allow for an efficient transfer. Additionally or alternatively, the indication of malfunction may be received after the associated network port is offline, inactive, or inoperable, and, therefore, such that operations by the intermediate switch may be responsive as opposed to proactive.

In an instance in which each network port of the network port pairs (e.g., the first network port pair, the second network port pair, etc.) are operable, the redundant network ports (e.g., the first redundant input network port and/or the first redundant output network port) may remain offline, dormant, or otherwise inoperable. In an instance in which the indication of malfunction is associated with the first output network port, the method proceeds to Block 410 of FIG. 4. In an instance in which the indication of malfunction is associated with the first input network port, the operations proceed to Block 420 of FIG. 4.

Referring now to Block 410 of FIG. 4, the method may include establishing communication between the first input network port and a first redundant network port in an instance in which the intermediate switch receives an indication of a malfunction associated with the first output network port. In various embodiments, in an instance in which the first output network port is malfunctioning, the first input network port may be communicably connected to any redundant network port (e.g., a redundant output network port or the like) via the intermediate switch. In such an instance, the connection between the first input network port and the first output network port is terminated to allow for the malfunction associated with the first output network port to be addressed.

Referring now to Block 420 of FIG. 4, the method may include establishing communication between the first output network port and the first redundant network port in an instance in which the intermediate switch receives an indication of a malfunction associated with the first input network port. In various embodiments, in an instance in which the first input network port is malfunctioning, the first output network port may be communicably connected to any redundant network port (e.g., the redundant input network port or the like) via the intermediate switch. In such an instance, the connection between the first input network port and the first output network port is terminated to allow for the malfunction associated with the first input network port to be addressed.

Referring now to optional Block 430 of FIG. 4, the method may include receiving an indication that the malfunction associated with the first input network port or the first output network port has been resolved. The malfunction may be resolved in various ways, such as determining the indication of malfunction was unnecessary, repairing any malfunctions, replacing the network port, preforming any maintenance on the network port, and/or the like. The indication that the malfunction is resolved may be automated provided by a system operator or user, etc. For example, the connection between the network port associated with the malfunction indication and the intermediate switch may be restored, such that the intermediate switch determines that the particular network port is now operational.

In various embodiments, the indication that the malfunction associated with the first input network port and the first output network port has been resolved may be received from a user. For example, the system may include a user interface that allows the user to indicate that the malfunction has been resolved. In some instances, the system may receive the indication from a user that the malfunction is resolved, and the system may perform one or more automated communications with the particular network port to confirm that the network port is operational.

Referring now to optional Block 440 of FIG. 4, the method may include reestablishing communication between the first input network port and the first output network port based upon the indication that the malfunction associated with the first input network port and the first output network port has been resolved. Additionally, any communication with the redundant network port may also be terminated and the redundant network port may return to an inoperable, dormant, or offline state, so as to avoid unnecessary hardware and/or energy usage.

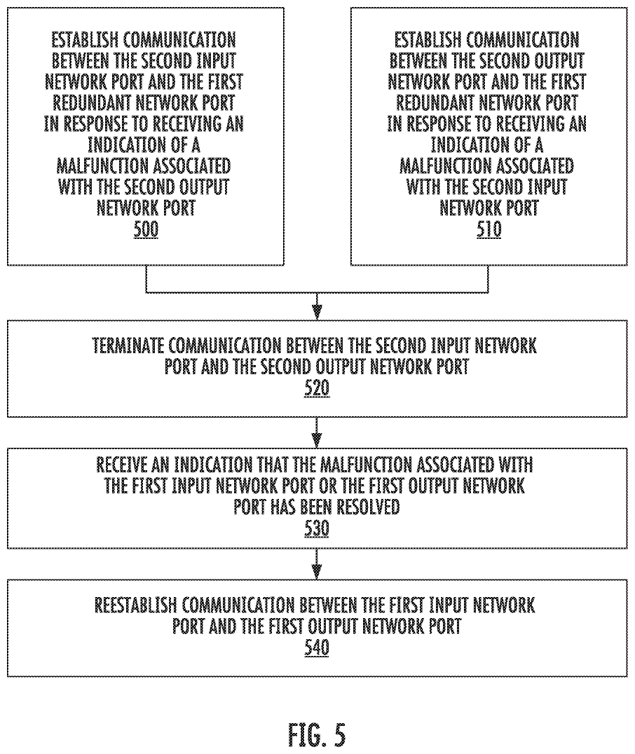

With reference to FIG. 5, a flowchart is provided for network resilience in multiport implementations, such as system 200 in FIG. 2. As described above, the systems described herein may include a plurality of network port pairs, each in communication with the intermediate switch. As such, each of the additional network port pairs may use any redundant network port(s) communicably coupled with the intermediate switch. In various embodiments, a plurality of redundant input network ports or redundant output network ports may be provided to allow for an instance in which multiple network ports are malfunctioning at a particular time. Furthermore, although described as redundant network ports assigned to operations for the input or output network ports, the present disclosure contemplates that any redundant network port may operate to provide resilience for any network port pair based upon the intended application of the system.

Similar to Block 400 of FIG. 4, the system may receive an indication of a malfunction associated with the second input network port or the second output network port. In an instance in which the indication of a malfunction is associated with the second output network port, the operations of FIG. 5 begin at Block 500. In an instance in which the indication of a malfunction is associated with the second input network port, the operations of FIG. 5 begin at Block 510.

Referring now to Block 500 of FIG. 5, the method may include establishing communication between the second input network port and the first redundant network port in response to receiving an indication of a malfunction associated with the second output network port. As shown in FIG. 2, the second input network port may be communicably connected to the redundant output network port via the intermediate switch. The intermediate switch may determine whether the redundant output network port is currently in operation (e.g., being used for a malfunction in another network port pair). Upon determining the redundant output network port 120 is not in operation, the communication between the second input network port and the redundant output network port 120 is established.

Referring now to Block 510 of FIG. 5, the method may include establishing communication between the second output network port and the first redundant network port in response to receiving an indication of a malfunction associated with the second input network port. As shown in FIG. 2, the second output network port may be communicably connected to the redundant input network port via the intermediate switch. The intermediate switch may determine whether the redundant input network port is currently in operation (e.g., being used for a malfunction in another network port pair). Upon determining the redundant input network port is not in operation, the communication between the second output network port and the redundant input network port is established.

Referring now to Block 520 of FIG. 5, the method may include terminating communication between the second input network port and the second output network port in response to receiving the indication of the malfunction associated with the second output network port or in response to receiving the indication of the malfunction associated with the second input network port. As discussed in reference to FIG. 4, the malfunctioning network port may be isolated from the network to allow for the malfunction to be investigated and/or addressed.

Referring now to Block 530 of FIG. 5, the method may include receiving an indication that the malfunction associated with the first input network port or the first output network port has been resolved. The indication that the malfunction has been resolved may be substantially the same as the indication discussed in reference to Block 430 of FIG. 4.

Referring now to Block 540 of FIG. 5, the method may include reestablishing communication between the first input network port and the first output network port in response to receiving the indication that the malfunction associated with the first input network port or the first output network port has been resolved. In addition, the communication between the non-malfunctioning network port and the given redundant network port may be terminated (e.g., the redundant network ports are taken offline to avoid additional strain on the system).

### Example Network Configurations

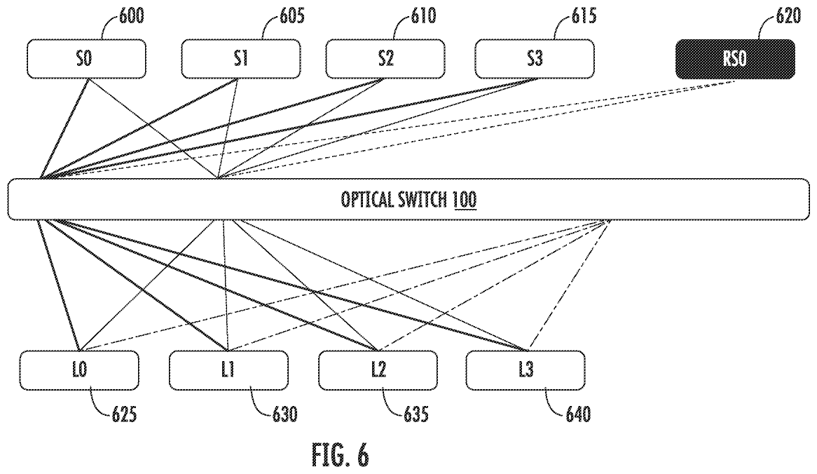

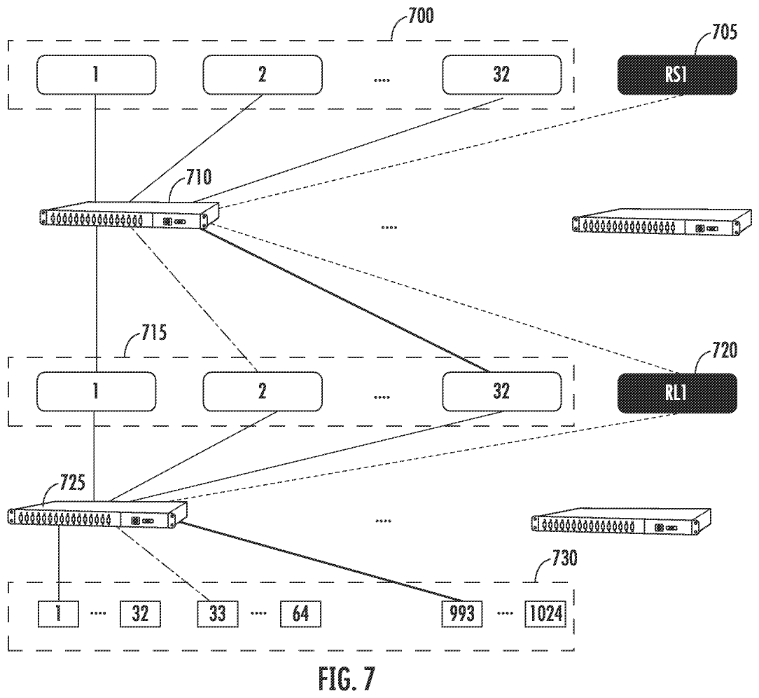

FIGS. 6 and 7 illustrate additional embodiments in which an intermediate switch 100 of various embodiments may be used. FIG. 6 illustrates an example system for network resilience applied to a spine-leaf architecture in which an intermediate switch 100 is connected or coupled to a set of input network ports and a set of output network ports. The input network ports may include a plurality of spine switches (e.g., switches 600, 605, 610, and 616) with an additional redundant network port (e.g., a redundant spine switch 620). The output network ports may include four leaf switches (e.g., switches 625, 630, 635, 640). Each of the output network ports (e.g., switches 625, 630, 635, 640) may be communicably connected to each of switches 600, 605, 610, 616 (e.g., each of the switches 600, 605, 610, 616 may define a subport configured to communicate with each of the spine switches).

In an instance in which any of switches 600, 605, 610, 616 malfunction, require maintenance, etc. each of the output network ports (e.g., switches 625, 630, 635, 640) may be communicably connected to the redundant network ports of the redundant spine switch 620. As such, communication with the malfunctioning switch may be terminated. Such communication may be reestablished upon receiving an indication that the malfunction is resolved as discussed above in reference to FIGS. 4 and 5. While FIG. 6 is illustrated using switches, various network ports of any type or amount may be used similarly with an intermediate switch 100.

FIG. 7 illustrates system for network resilience applied to a multilayer architecture (e.g., multiple layers of network ports and/or intermediate switches). As shown, a first layer of network ports 700 may be provided in communication with intermediate switch(es) 710. The first layer of network ports may also include a redundant network port 705 that operates as a redundant network port for the first layer of network ports 700. The first layer of network ports may be communicably connected to a second layer of network ports 715 via the intermediate switch(es) 710. The second layer of network ports may also include a redundant network port 720 that operates as a redundant network port for the second layer of network ports 715.

Additionally, the second layer of network ports 715 (e.g., an additional layer network port) may be in communication with intermediate switch(es) 725. The second layer of network ports 715 may be communicably connected to a third layer of network ports 730 via the intermediate switch(es) 725 (e.g., an additional intermediate switch). Each layer of network ports may be the same or different types of network ports. For example, the first layer of network port 700 and the second layer of network ports 715 may be electrical switches, while the third layer of network ports 730 may be hosts. Additionally, each layer of network ports may have one or more redundant network ports. For example, while only the first layer of network ports 700 and the second layer of network ports 715 are shown with redundant network ports, the third layer of network ports 730 may also have one or more redundant network ports. Additionally, the number of redundant network ports is merely illustrative and could be more than one redundant network port at each layer of network ports and/or each redundant network port may be accessible by network ports and/or intermediate switches at different levels or layers.

FIG. 7 further illustrates the ability of the embodiments described herein to scale while minimizing the impact of malfunctions, maintenance, and/or any offline condition of a particular port with other proximate ports (e.g., minimize the “blast radius” and/or “collateral damage”). By way of example, each network port 730 may be connected to a different intermediate switch of the plurality of intermediate switches 725. As such, in the event of an offline condition or failure of a particular intermediate switch 725, only a single port 730 (e.g., a single port per endpoint) may be impacted. Furthermore, the embodiments described herein may also operate to scale in size given that the optical switch does not limit the total ports of the endpoints in the network. Additionally, domains for failure recovery may be generated in that, for example in the illustrated intermediate switch 725, a first port of the 1^{st}, 33^{rd}, and 65^{th} endpoint may be connected. In another intermediate switch, a second port of the 1^{st}, 33^{rd}, and 65^{th} endpoint may be connected. Such an example procedure may be followed for the each of the ports/endpoints. In doing so, an electrical switch failure may be handled by multiple optical switches (e.g., the connection rearrangement required for each failure is shared among them).

Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A system for resilience in network communications, the system comprising:
a first network port pair comprising:
a first input network port; and
a first output network port;
an intermediate switch configured to communicably connect the first input network port and the first output network port in an instance in which each of the first input network port and the first output network port are operable; and
a first redundant network port communicably connected with the intermediate switch,
wherein the intermediate switch is configured to:
establish communication between the first input network port and the first redundant network port in an instance in which the intermediate switch receives an indication of a malfunction associated with the first output network port; or
establish communication between the first output network port and the first redundant network port in an instance in which the intermediate switch receives an indication of a malfunction associated with the first input network port.

2. The system of claim 1, wherein the intermediate switch is further configured to terminate communication between the first input network port and the first output network port in response to the indication of the malfunction associated with the first output network port or the first input network port.

3. The system of claim 2, wherein the intermediate switch is further configured to:
terminate communication between the first redundant network port and the first input network port and reestablish communication between the first input network port and the first output network port in response to an indication that the malfunction associated with the first output network port is resolved; and
terminate communication between the first redundant network port and the first output network port and reestablish communication between the first input network port and the first output network port in response to an indication that the malfunction associated with the first input network port is resolved.

4. The system of claim 1, further comprising:
a second network port pair comprising a second input network port and a second output network port, wherein the intermediate switch communicably connects the second input network port and the second output network port in an instance in which the second input network port and the second output network port are operable,
the intermediate switch further configured to:
establish communication between the second input network port and the first redundant network port in an instance in which the intermediate switch receives an indication of a malfunction associated with the second output network port; or
establish communication between the second output network port and the first redundant network port in an instance in which the intermediate switch receives an indication of a malfunction associated with the second input network port.

5. The system of claim 4, further comprising:
a second redundant network port communicably connected with the intermediate switch,
wherein the intermediate switch is further configured to:
establish communication between the second redundant network port and the second output network port in an instance in which the intermediate switch receives an indication of a malfunction associated with the second input network port, or
establish communication between the second redundant network port and the second input network port in an instance in which the intermediate switch receives an indication of a malfunction associated with the second output network port.

6. The system of claim 1, wherein the intermediate switch comprises a plurality of sub-switches.

7. The system of claim 1, wherein the first input network port, the first output network port, and the first redundant network port are electrical switches, and the intermediate switch is an optical switch.

8. The system of claim 1, further comprising:
an additional layer network port;
an additional intermediate switch configured to communicably connect the additional layer network port and the first input network port in an instance in which the additional layer network port and the first input network port are operable; and
a second redundant network port communicably connected with the additional intermediate switch, wherein the additional intermediate switch is configured to:
establish communication between the additional layer network port and the second redundant network port in an instance in which the additional intermediate switch receives an indication of a malfunction associated with the first input network port, or
establish communication between the first input network port and the second redundant network port in an instance in which the additional intermediate switch receives an indication of a malfunction associated with the additional layer network port.

9. The system of claim 8, wherein the additional intermediate switch is further configured to terminate communication between the additional layer network port and the first input network port in response to the indication of the malfunction associated with the first input network port.

10. The system of claim 1, further comprising a controller operably coupled with the intermediate switch configured to direct communications between the first input network port, the first output network port, and the first redundant network port.

11. An apparatus for resilience in network communications, the apparatus communicably connecting a first input network port and a first output network port in an instance in which each of the first input network port and the first output network port are operable,
wherein the apparatus is configured to:
establish communication between the first input network port and a first redundant network port in an instance in which the apparatus receives an indication of a malfunction associated with the first output network port; or
establish communication between the first output network port and the first redundant network port in an instance in which the apparatus receives an indication of a malfunction associated with the first input network port.

12. The apparatus of claim 11, further configured to terminate communication between the first input network port and the first output network port in response to the indication of the malfunction associated with the first output network port or the first input network port.

13. The apparatus of claim 11, further configured to communicably connect a second input network port and a second output network port in an instance in which the second input network port and the second output network port are operable,
wherein the apparatus is further configured to:
establish communication between the second input network port and the first redundant network port in response to receiving an indication of a malfunction associated with the second output network port, or
establish communication between the second output network port and the first redundant network port in response to receiving an indication of a malfunction associated with the second input network port.

14. The apparatus of claim 11, wherein, in an instance in which the apparatus receives an indication of a malfunction associated with the first input network port, the apparatus is configured to establish communication between the first output network port and a second redundant network port.

15. A method for providing resilience in network communications, the method comprising:
receiving an indication of a malfunction associated with a first input network port or a first output network port, wherein the first input network port and the first output network port are communicably connected via an intermediate switch in an instance in which each of the first input network port and the first output network port are operable;
establishing communication between the first input network port and a first redundant network port in an instance in which the intermediate switch receives the indication of the malfunction associated with the first output network port; or
establishing communication between the first output network port and the first redundant network port in an instance in which the intermediate switch receives the indication of the malfunction associated with the first input network port.

16. The method of claim 15, further comprising:
receiving an indication that the malfunction associated with the first input network port or the first output network port has been resolved; and
reestablishing communication between the first input network port and the first output network port.

17. The method of claim 15, further comprising establishing communication between a second input network port and a second output network port in an instance in which the second input network port and the second output network port are operable.

18. The method of claim 17, further comprising:
establishing communication between the second input network port and the first redundant network port in response to receiving an indication of a malfunction associated with the second output network port; or
establishing communication between the second output network port and the first redundant network port in response to receiving an indication of a malfunction associated with the second input network port.

19. The method of claim 18, further comprising terminating communication between the second input network port and the second output network port in response to receiving the indication of the malfunction associated with the second output network port or in response to receiving the indication of the malfunction associated with the second input network port.

20. The method of claim 19, further comprising:
receiving an indication that the malfunction associated with the second input network port or the second output network port has been resolved; and
reestablishing communication between the second input network port and the second output network port.
